(19) United States
(12) Patent Application Publication
(10) Pub. No.: US 2024/0281318 A1
(43) Pub. Date: Aug. 22, 2024

(54) METHOD TO PREDICT THE IMPACT OF CHANGES TO THE SURROUNDING SYSTEMS IN A DATACENTER

(71) Applicant: Dell Products L.P., Round Rock, TX (US)

(72) Inventors: Parminder Singh Sethi, Ludhiana (IN); Lakshmi Saroja Nalam, Bangalore (IN)

(21) Appl. No.: 18/172,844

(22) Filed: Feb. 22, 2023

(51) Int. Cl. G06F 11/07; H04L 41/0677

(52) U.S. Cl. CPC G06F 11/0793; H04L 41/0677

(57) ABSTRACT

In general, embodiments described herein relate to methods, systems, and non-transitory computer readable mediums storing instructions for re-configuring and/or repairing at least one datacenter element, when a change is detected in the datacenter. In one or more embodiments the datacenter may be running multiple applications on multiple individual computing devices. Each of these devices need to be correctly configured both locally and in the larger computing system in order to allow the applications to function correctly and efficiently. An analyzer, along with other components of the datacenter, determines dependencies and remediation steps for elements such as hardware and/or applications of the datacenter that have been changed. Based on determined dependencies and the system configuration, the analyzer may determine any physical changes needed to be made to the datacenter as well as ideal configurations for any affected datacenter elements including both hardware and software elements.

### BACKGROUND

In an enterprise environment, a system might be running multiple applications that are either working together or dependent on each other. The system may take the form of a datacenter and comprise of many elements including both hardware and software. When a datacenter element is changed or a new element is added to the datacenter, the datacenter must be correctly configured to use the datacenter element or unexpected downtime, decreased performance, and/or complete failure of applications may occur.

### SUMMARY

In general, embodiments described herein relate to a method for mitigating impacts of changes in a datacenter. The method initially retrieves telemetry from the datacenter and detects, using the telemetry, a change in the datacenter. The method then determines that the change in the datacenter has affected one or more datacenter elements and identifies the affected one or more datacenter elements. The method makes a component tree for the identified affected one or more datacenter elements and from at least the component tree determines one or more remediation steps. Performance of the one or more remediation steps are then initiated. The one or more remediation steps include making changes to at least one of the one or more affected datacenter elements.

In general, embodiments described herein relate to a non-transitory computer readable medium comprising computer readable program code. The computer readable code, which when executed by a computer processor, enables the computer processor to perform a method for mitigating impacts of changes in a datacenter. The method initially retrieves telemetry from the datacenter and detects, using the telemetry, a change in the datacenter. The method then determines that the change in the datacenter has affected one or more datacenter elements and identifies the affected one or more datacenter elements. The method makes a component tree for the identified affected one or more datacenter elements and from at least the component tree determines one or more remediation steps. The one or more remediation steps are then performed. The one or more remediation steps include making changes to at least one of the one or more affected datacenter elements.

In general, embodiments described herein relate to a datacenter which comprises at least one processor and at least one memory. The memory includes instructions, which when executed by the processor perform a method for mitigating impacts of changes in a datacenter. The method initially retrieves telemetry from the datacenter and detects, using the telemetry, a change in the datacenter. The method then determines that the change in the datacenter has affected one or more datacenter elements and identifies the affected one or more datacenter elements. The method makes a component tree for the identified affected one or more datacenter elements and from at least the component tree determines one or more remediation steps. The one or more remediation steps are then performed. The one or more remediation steps include making changes to at least one of the one or more affected datacenter elements.

Other aspects of the embodiments disclosed herein will be apparent from the following description and the appended claims.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows a diagram of a system in accordance with one or more embodiments of the invention.

FIG. 2A shows a diagram of a technical support system (TSS) in accordance with one or more embodiments of the invention.

FIG. 2B shows a diagram of a normalization and filtering module and a flowchart about the operation of the normalization and filtering module in accordance with one or more embodiments of the invention.

FIG. 2C shows a diagram of a shared storage in accordance with one or more embodiments of the invention.

FIG. 3 shows a sample component tree in accordance with one or more embodiments of the invention.

FIG. 4 shows a flowchart of a method for detecting a change to a datacenter and remediated its impact in accordance with one or more embodiments of the invention.

FIG. 5 shows a computing system in accordance with one or more embodiments of the invention.

### DETAILED DESCRIPTION

In the below description, numerous details are set forth as examples of embodiments described herein. It will be understood by those skilled in the art, and having the benefit of this Detailed Description, that one or more embodiments of embodiments described herein may be practiced without these specific details and that numerous variations or modifications may be possible without departing from the scope of the embodiments described herein. Certain details known to those of ordinary skill in the art may be omitted to avoid obscuring the description.

In the below description of the figures, any component described with regards to a figure, in various embodiments described herein, may be equivalent to one or more like-named components described with regard to any other figure. For brevity, descriptions of these components will not be repeated with regards to each figure. Thus, each and every embodiment of the components of each figure is incorporated by reference and assumed to be optionally present within every other figure having one or more like-named components. Additionally, in accordance with various embodiments described herein, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

In general, embodiments described herein relate to methods, systems, and non-transitory computer readable mediums storing instructions for re-configuring and/or repairing at least one datacenter element, when a change is detected in the datacenter. In one or more embodiments the datacenter may be running multiple applications on multiple individual computing devices. Each of these devices need to be correctly configured both locally and in the larger computing system in order to allow the applications to function correctly and efficiently.

Previously when a change in one or more elements of the datacenter was made, such as, but not limited to, the introduction of a new hardware element, a failure of an old hardware element, and/or the installation or update of one or more applications; an user/administrator would receive a major incident management (MIM) alert or ticket and they would have to manually determine the source of the change, make any needed changes to the hardware, and re-configured the system. However, the user/administrator is often unaware of the ideal configuration for the system, and when a system becomes increasingly complicated such as a large datacenter, even if the user/administrator understands the ideal configuration for the hardware, its often difficult to determine which of a plurality of affected elements of the datacenter is causing the problem and the user/administrator may not be aware of all the other applications and/or devices that need re-configured.

Further, modern complex computing systems such as datacenters, cloud, edge, and other computing environments, multiple systems, and applications are potentially geographically dispersed and comprise of many different elements. Making changes without understanding all of the dependent elements that may be located both locally and across other datacenters, cloud, and/or edge environments, may result in the new hardware not being efficiently used and/or even failing. Even if the user or administrator is successful in re-configuring and ameliorating any problems caused by the change in the datacenter at one location, this might not be the correct or best configuration for the larger networked system.

In order to avoid such problems, one or more embodiments of the invention, proposes introducing an additional device or service: an analyzer. The analyzer, along with other components of the datacenter, determines dependencies and remediation steps for elements such as hardware and/or applications of the datacenter that have been changed. Based on determined dependencies and the system configuration, the analyzer may determine any physical changes needed to be made to the datacenter as well as ideal configurations for any affected datacenter elements including both hardware and software elements. This results in making correcting any problems that arise during the day-to-day operations of a datacenter, less burdensome to users and administrators. Ultimately making the datacenter more reliable and easier to maintain.

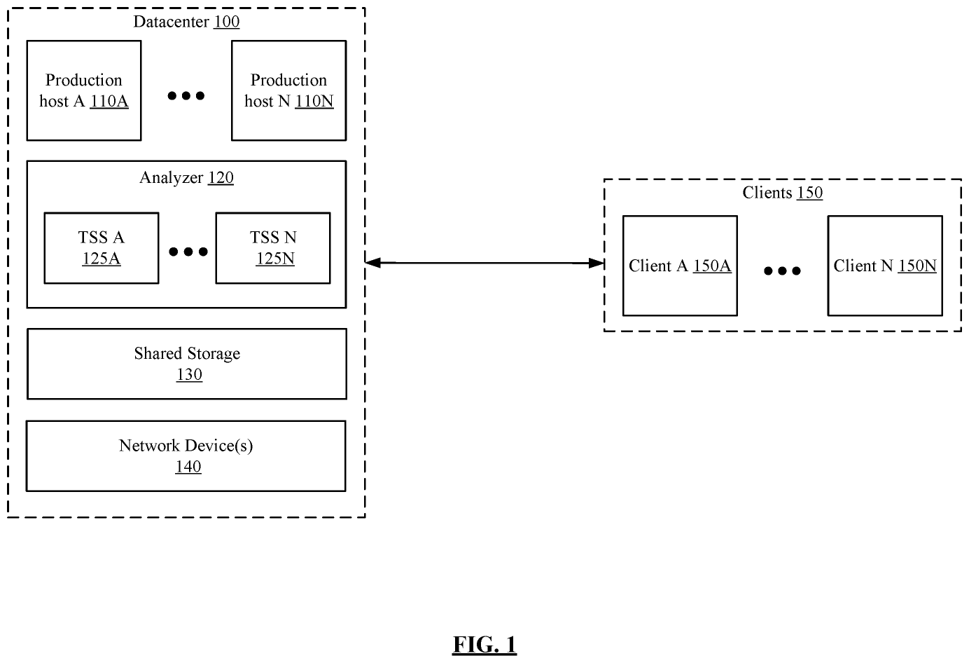

FIG. 1 shows a diagram of a system that performs the claimed methods in one or more embodiments of the invention. The system includes a datacenter (100) and clients (150). The datacenter (100) may be connected to one or more clients (e.g., 150) through a network (not shown). The datacenter (100) may be located in a single location or may be spread over a plurality of locations and/or be part of a cloud or edge-based computing environment. The datacenter (100) as well as the clients (150) may include more or less components then shown. The system may include additional, fewer, and/or other components without departing from the invention. Each of the components in the system may be operatively connected via any combination of wireless and/or wired networks (not shown). Each component illustrated in FIG. 1 is discussed below.

In one or more embodiments of the invention, the datacenter (e.g., 100) interacts with one or more clients (e.g., 150A-150N) via a network (not shown). The clients (150) are separate computing systems or proxies that utilize the services of the one or more production hosts (e.g., 110A-110N) which will be described in more detail below. The clients (150), in one or more non-limiting examples, may be one or more user's local computers that they use to access the resources of the datacenter (100) including functioning as a remote desktop. In one or more embodiments of the invention, the clients (150) may also take the form of a workstations for users and/or administrators who maintain and/or configure the datacenter (100). The clients (150) may take any form that utilizes assets (such as but not limited to files and folders), data, and/or applications associated with the datacenter (100).

In one or more embodiments of the invention, assets such as data, files, folders, and/or applications may be shared or transferred back and forth between the client (e.g., 150) and the datacenter (100). Any data related to an asset such as its files and folders may be stored in the client's storage (not shown), in the shared storage (e.g., 130), or in storage associated with one or more production hosts (e.g., 110A-110N). In one or more embodiments of the invention, the clients (e.g., 150) may include functionality to use services provided by the datacenter (100). For example, the clients (e.g., 150) may host local applications that interact with applications hosted by the production hosts (e.g., 110A-110N).

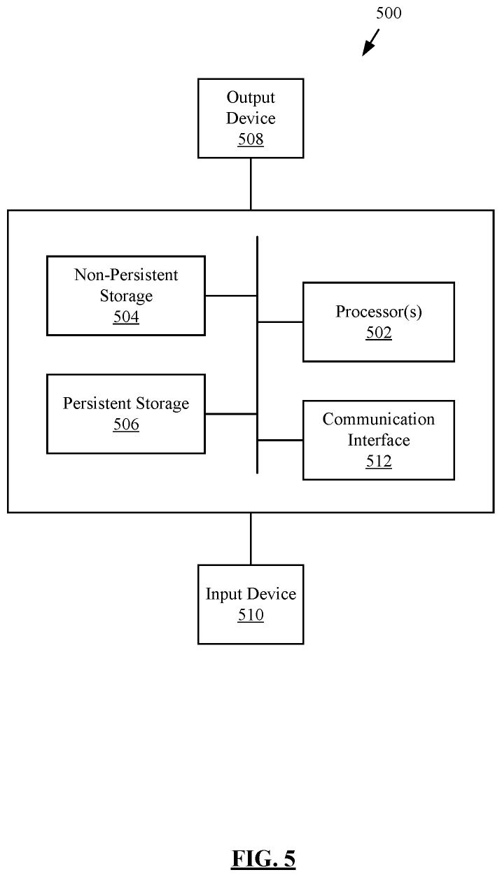

In one or more embodiments of the invention, the client (150) is implemented as a computing device (see e.g., FIG. 5). The computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the client (150) described throughout this application.

In one or more embodiments of the invention, the client (150) is implemented as a logical device. The logical device may utilize the computing resources of any number of computing devices and thereby provide the functionality of the client (150) described throughout this application.

In one or more embodiments of the invention, clients (150) and the datacenter (100) communicate through a network (not shown). The network may take any form including any combination of wireless and/or wired networks. The network may be a local network (LAN) or a wide area network (WLAN) including the Internet or a private enterprise network that connects more than one location. The network may be any combination of the above networks, other known network, or any combination of network types.

In one or more embodiments of the invention, the network allows the datacenter (100) to communicate with other datacenters (not shown) and external computing devices such as (but not limited to) a client (e.g., 150A-150N). The various components of the datacenter (150) may also communicate with each other through a network. The network may be a high-speed internal network and/or include part of an external network.

The one or more elements of the datacenter (100) may communicate over one or more networks using encryption. In one or more embodiments of the invention the individual elements of the datacenter may communicate with each other using strong encryption. The individual elements of the datacenters may also communicate with clients (e.g., 150) using strong encryption such as, but not limited to, 128-bit encryption. Other forms of encryption such as, but not limited to, symmetric-key schemes, public-key schemes, RSA, etc. may be used for communicating between the datacenters, nodes, and other components and entities without departing from the invention.

A network may refer to an entire network or any portion thereof (e.g., a logical portion of the devices within a topology of devices). A network may include a datacenter network, a wide area network, a local area network, a wireless network, a cellular phone network, and/or any other suitable network that facilitates the exchange of information from one part of the network to another. A network may be located at a single physical location or be distributed at any number of physical sites. In one or more embodiments, a network may be coupled with or overlap, at least in part, with the Internet.

In one or more embodiments of the invention the datacenter (100) includes one or more network devices (e.g., 140) for communicating with external networks (such as, but not limited to the Internet) as well as internal networks including those connecting the various elements of the datacenter (100). The network devices (e.g., 140), in one or more embodiments of the invention, may take the form of a network interface card (NIC). In one or more embodiments, a network device (e.g., 140) is a device that includes and/or is operatively connected to persistent storage (not shown), memory (e.g., random access memory (RAM)) (not shown), one or more processor(s) (e.g., integrated circuits) (not shown), and at least two physical network interfaces, which may provide connections (i.e., links) to other devices (e.g., computing devices, other network devices, etc.). In one or more embodiments, a network device (e.g., 140) also includes any number of additional components (not shown), such as, for example, network chips, field programmable gate arrays (FPGAs), application specific integrated circuits (ASICs), indicator lights (not shown), fans (not shown), etc. A network device (e.g., 140) may include any other components without departing from the invention. Examples of a network device (e.g., 140) include, but are not limited to, a network switch, a router, a multilayer switch, a fibre channel device, an InfiniBand® device, etc. A network device (e.g., 140) is not limited to the aforementioned specific examples.

The datacenter (100) may comprise of a plurality of elements that may include both physical (hardware) devices and software such as applications and virtual devices which in one or more embodiments of the invention provide one or more services and/or interact with the clients (e.g., 150). In one or more embodiments of the invention, the datacenter (100) includes a plurality of elements such as production hosts (e.g., 110A-110N), an analyzer (120), shared storage (130), and the one or more network devices (e.g., 140). Each of the elements communicates with the other elements of the datacenter (100) through internal networks and/or external networks when all of the elements are not geographically co-located. The elements also communicate and/or provide services to the clients (e.g., 150).

In one or more embodiments of the invention, the datacenter (100) includes a plurality of production hosts (e.g., 110A-110N) which include functionality to provide services and/or data to clients (e.g., 150) and/or other datacenters (not shown) and/or other production hosts (e.g., 110A-110N). While shown as containing only two production hosts (110A and 110N), the datacenter (100) may include more or less production hosts without departing from the invention, for example a datacenter (e.g., 100) may include of at least sixteen production hosts, at least fifty production hosts, or at least a hundred production hosts without departing from the invention.

In one or more embodiments of the invention, the production hosts (e.g., 110A-110N) perform workloads and provide services to clients (e.g., 150) and/or other entities not shown in the system illustrated in FIG. 1. The production hosts (e.g., 110A-110N) may further include the functionality to perform computer implemented services for users (e.g., clients 150) of the datacenter (100). The computer implemented services may include, for example, database services, electronic mail services, data processing services, etc. The computer implemented services may include other and/or additional types of services without departing from the invention.

The production hosts (also referred to as nodes) (e.g., 110A-110N) may include a primary production host (e.g., 110A) and secondary production hosts (e.g., 102N). The specific configuration of which production host is the primary production host and which production host is the secondary production host may be preconfigured or may be automatically managed by a group manager (not shown). The production hosts (e.g., 110A-110N) may include any number of secondary production hosts without departing from the invention. Alternatively, all production hosts (e.g., 110A-110N) may be secondary production hosts with a group manager, clients (150) and/or the analyzer (120) performing the additional tasks of the primary host.

During the performance of the aforementioned services, data may be generated and/or otherwise obtained. The production hosts (e.g., 110A-110N) may include local storage (not shown), processors, and other hardware/software-based datacenter elements. In one or more embodiments of the invention, the production hosts (e.g., 110A-110N) are implemented as computing devices (see e.g., FIG. 5). A computing device may be, for example, a mobile phone, tablet computer, laptop computer, desktop computer, server, distributed computing system, or cloud resource. The computing device may include one or more processors, memory (e.g., random access memory), and persistent storage (e.g., disk drives, solid state drives, etc.). The computing device may include instructions, stored on the persistent storage, that when executed by the processor(s) of the computing device cause the computing device to perform the functionality of the production hosts (e.g., 110A-110N) described throughout this application.

In one or more embodiments of the invention, the production hosts (e.g., 110A-110N) are implemented as a logical device. The logical device may utilize the computing resources of any number of computing devices and thereby provide the functionality of the production hosts (e.g., 110A-110N) described throughout this application.

The production hosts (e.g., 110A-110N) as well as other components of the datacenter (100) and connected devices may perform data storage services. The data storage services may include storing, modifying, obtaining, and/or deleting data stored on the local and shared storage (e.g., 130) based on instructions and/or data obtained from the production hosts (e.g., 110A-110N) or other components of the datacenter (e.g., 100). The data storage services may include other and/or additional services without departing from the invention. The shared storage (e.g., 130) may include any number of storage volumes without departing from the invention.

Each production host (e.g., 110A-110N) may include local storage (not shown) and/or use the shared storage (130) for storing assets such as files and folders which may be made available to other hosts and/or clients (e.g., 150). The storage, either local storage or the shared storage (e.g., 130) may include one or more processors, memory (e.g., random access memory), and persistent storage (e.g., disk drives, solid state drives, etc.). In one or more embodiments of the invention, both the local storage and shared storage (e.g., 130) may also, or alternatively, comprise of off-site storage including but not limited to, cloud base storage, and long-term storage such as tape drives, depending on the particular needs of the user and/or the system. The group may also contain shared storage including at least one group shared volume which is active with each of the production hosts (e.g., 110A-110N) as well as the analyzer (e.g., 120). Other types of shared storage (e.g., 130) may also or alternatively be included such as active-passive storage and local storage.

The logical storage devices (e.g., virtualized storage) may utilize any quantity of hardware storage resources of any number of computing devices for storing data. For example, the local and shared storages (e.g., 130) may utilize portions of any combination of hard disk drives, solid state disk drives, tape drives, and/or any other physical storage medium of any number of computing devices.

In one or more embodiments of the invention, the datacenter (100) includes an analyzer (120). The analyzer (120) includes a plurality of technical support systems (TSSs) (e.g., 125A-125N) which, in one or more embodiments of the invention, also utilize the shared storage (130). In one or more embodiments of the invention, the analyzer (120) monitors the production hosts (e.g., 110A-110N) as well as other elements of the datacenter (100) to determine if any changes or problems have occurred in the datacenter (100), such as but not limited to, a new hardware or software element has been added or a configuration of a pre-existing hardware or software elements having changed. This may be done by monitoring the telemetry and/or logs of the one or more production hosts (e.g., 110A-110N) or other components of the datacenter (100). In one or more other embodiments of the invention, the one or more production hosts (e.g., 110A-110N) and/or other components of the datacenter (100) may signal the analyzer (120) that a change has occurred in an element of the datacenter.

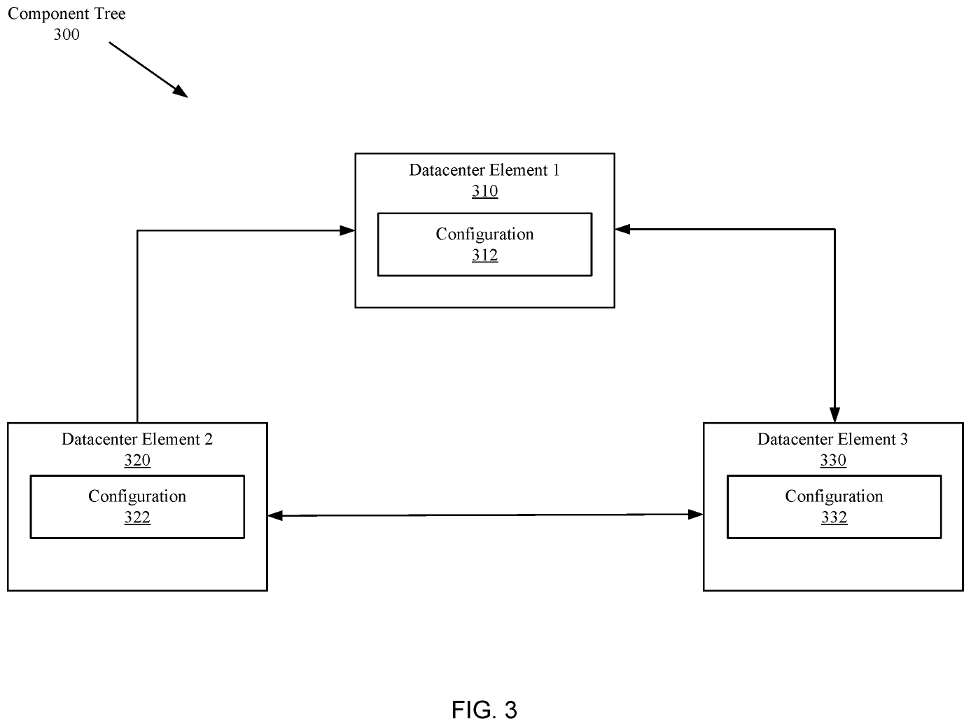

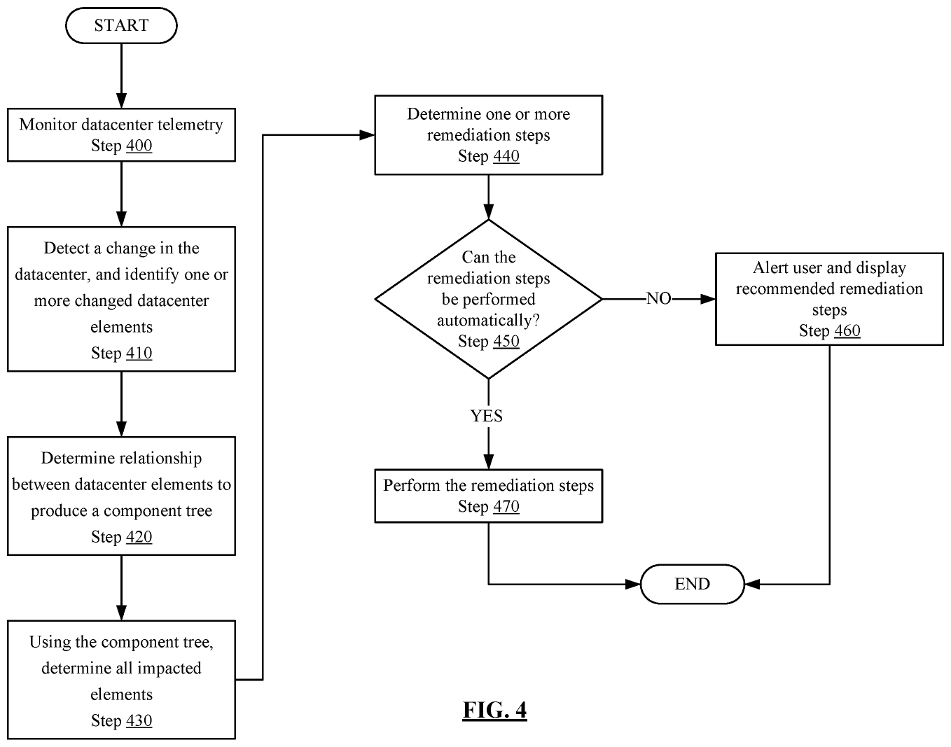

The analyzer (120) analyzes the telemetry and/or other information including, but not limited to, logs, and both network and internal communications/messages. The analyzer (12) uses the information/telemetry to produce a component tree and remediation recommendations as will be discussed in more detail with regards to the methods shown in FIG. 4 below. In one or more embodiments the component tree takes the from shown in FIG. 3, which will be described in more detail below.

As discussed above, the analyzer (120) includes a plurality of TSS (e.g., 125A-125N). Each of the TSSs (e.g., 125A-125N) may be operably connected to each other via any combination of wired/wireless connections. In one or more embodiments of the invention, the production hosts (e.g., 110A-110N) correspond to devices/elements (which may be physical or logical, as discussed below) that have been changed and/or are experiencing failures and that are directly or indirectly connected to the TSSs (e.g., 125A-125N), such that the production hosts (e.g., 110A-110N) and other elements of the datacenter (100) provide telemetry and/or logs to the TSS(s) for analysis (as further discussed below).

In one or more embodiments of the invention, each of the TSSs (e.g., 125A-125N) is a system to interact with the customers (via the clients (e.g., 150)) in order to resolve technical support issues. The TSSs (125A-125N) also in one or more embodiments of the invention are used for determining device profiles and producing remediation recommendations when the analyzer detects one or more datacenter elements have been changed and/or are added to the datacenter as described in more detail with respect to the methods shown in FIG. 4.

In one or more embodiments of the invention, the TSSs (e.g., 125A-125N) as well as the analyzer (120) in general, are implemented as a computing device (see e.g., 500, FIG. 5). The computing device may be, for example, a mobile phone, a tablet computer, a laptop computer, a desktop computer, a server, a distributed computing system, or a cloud resource. The computing device may include one or more processors, memory (e.g., random access memory), and persistent storage (e.g., disk drives, solid state drives, etc.). The computing device may include instructions stored on the persistent storage, that when executed by the processor(s) of the computing device, cause the computing device to perform the functionality of the TSSs (e.g., 125A-125N) described throughout this application.

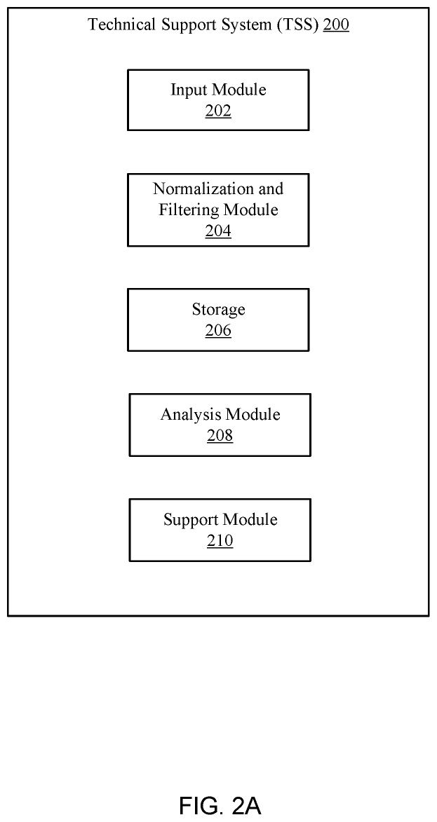

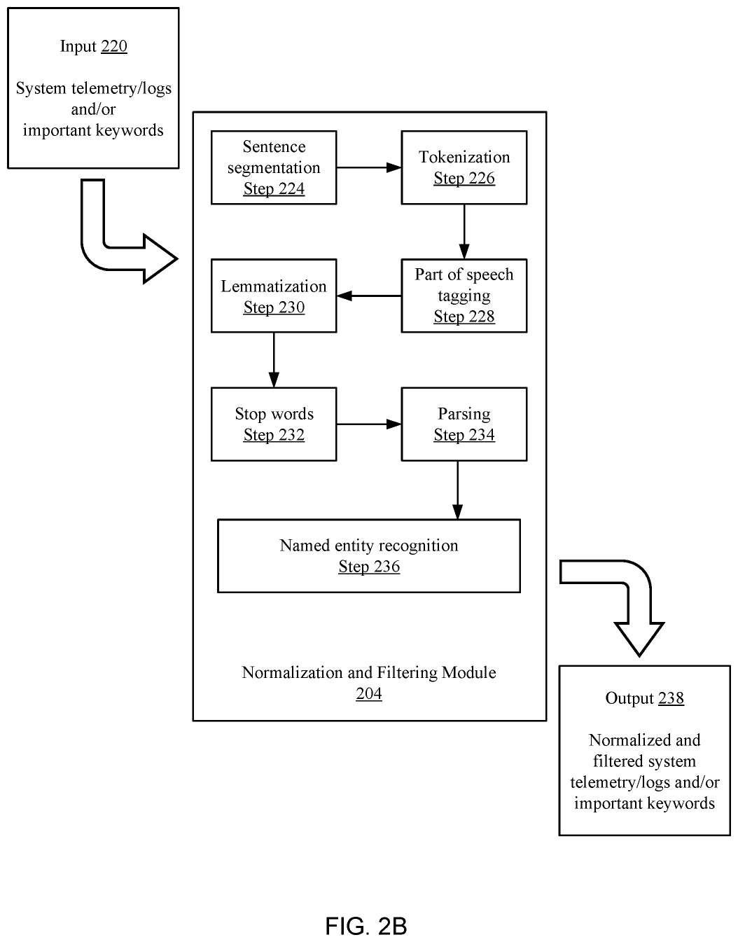

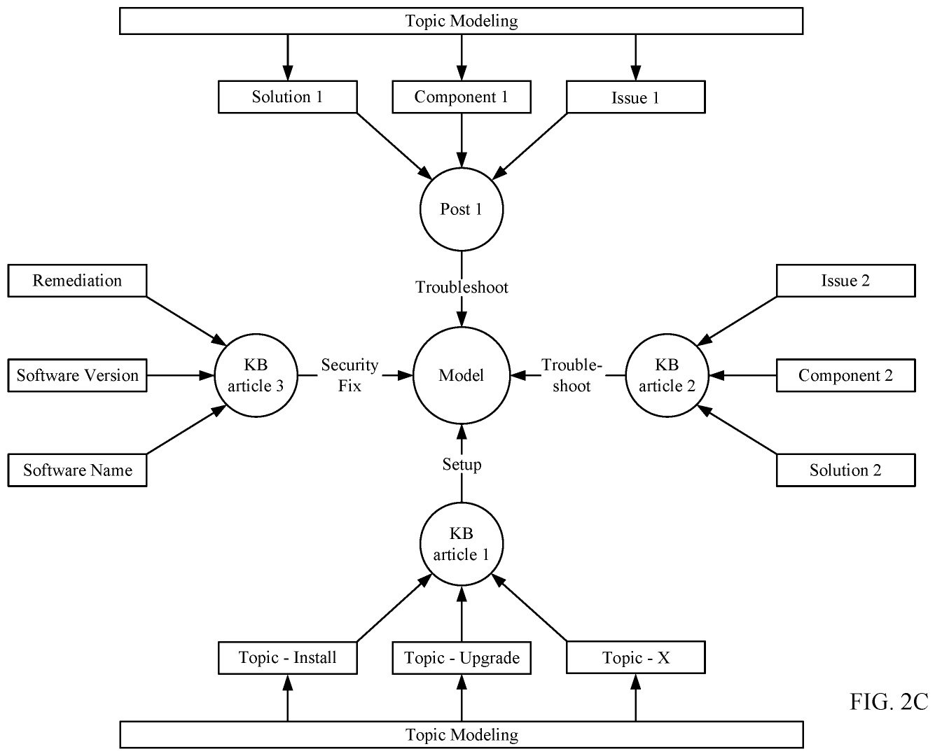

In one or more embodiments of the invention, the TSSs (e.g., 125A-125N) as well as the analyzer (120) in general, are implemented as a logical device. The logical device may utilize the computing resources of any number of computing devices and thereby provide the functionality of the TSSs (e.g., 125A-125N) described throughout this application. Additional detail about the TSSs (e.g., 125A-125N) are provided in FIGS. 2A-2C below.

In one or more embodiments of the invention, the analyzer (120) also utilizes and/or includes shared storage (130). The shared storage (130) as described above corresponds to any type of volatile or non-volatile (i.e., persistent) storage device that includes functionality to store unstructured data, structured data, etc. The shared storage (130) may provide storage for the TSS (e.g., 125A-125N) as well as store the component tree and hardware profile templates as will be discussed in more detail with regards to the methods of FIG. 4. The shared storage (130) may also store such things as knowledge base (KB) articles and/or any other information that may be used in performing the methods shown in FIG. 4. The shared storage (130), in one or more embodiments of the invention and as described above, may be separate from the analyzer (120) and/or part of either the production hosts (e.g., 110A-110N) or other components of the datacenter (100).

In one or more embodiments of the invention, the datacenter (100) may include additional elements (not shown). These elements may be, but not limited to, graphics processors/cards, specialty processors, security modules, and any other hardware or software that a particular production host (e.g., 110A-110N) or application hosted by a particular production host (e.g., 110A-110N) needs. Other devices and modules may be included in the datacenter (100) without departing from the invention.

While FIG. 1 shows a configuration of components, other configurations may be used without departing from the scope of embodiments described herein. For example, although FIG. 1 shows all components as part of two devices, any of the components may be grouped in sets of one or more components which may exist and execute as part of any number of separate and operatively connected devices. Accordingly, embodiments disclosed herein should not be limited to the configuration of components shown in FIG. 1.

Turning now to FIG. 2A, FIG. 2A shows a diagram of a technical support system (TSS) in accordance with one or more embodiments of the invention. The TSS of FIG. 2A may be similar to that described in FIG. 1 (e.g., 125A-125N). The TSS (200) includes an input module (202), a normalization and filtering module (204), storage (206), an analysis module (208), and a support module (210). Each of these components is described below.

In one or more embodiments of the invention, the input module (202) is any hardware, software, or any combination thereof that includes functionality to obtain system logs (e.g., transition of device states, an alert for medium level of central processing unit (CPU) overheating, new hardware detection, etc.) and important keywords for the computing device (e.g., new hardware identification and configuration) related to the new hardware component. The input module (202) may include functionality to transmit the obtained system logs and important keywords to the normalization and filtering module (204) as an input.

In one or more embodiments of the invention, the normalization and filtering module (204) processes the input received from the input module (202) and extracts the relevant data. Additional details for the normalization and filtering module (204) are provided in FIG. 2B.

In one or more embodiments of the invention, the storage (206) corresponds to any type of volatile or non-volatile (i.e., persistent) storage device that includes functionality to store extracted relevant data by the normalization and filtering module (204). In various embodiments of the invention, the storage (206) may also store a device state path. In one or more embodiments of the invention, the storage (206) may be separate from the TSS (200) and take the form of the shared storage (e.g., 130, FIG. 1) as described above with regards to FIG. 1.

In one or more embodiments of the invention, the analysis module (208) is configured to predict a next device state of a device based on a current device state of the device. The analysis module (208) may also be able to determine relationships between components and applications in order to produce a component tree as will be described in more detail below with regards to FIG. 3. The analysis module (208) may be implemented using hardware, software, or any combination thereof. Additional detail about the analysis module (208) is provided below.

In one or more embodiments of the invention, the support module (210) is configured to obtain solutions or workaround documents for previous and new hardware components. The support module (210) may include functionality to analyze the obtained documents and to store them into the shared storage (e.g., 130, FIG. 1). Based on a context-aware search performed in the shared storage (e.g., 130, FIG. 1), the support module provides the most relevant hardware and software profile templates for configuring elements of the datacenter that have changed as well as those elements that are related to the changed elements. The support module (210) may be implemented using hardware, software, or any combination thereof.

Turning now to FIG. 2B, FIG. 2B shows a diagram of a normalization and filtering module and a flowchart about the operation of the normalization and filtering module in accordance with one or more embodiments of the invention. The normalization and filter module in one or more embodiments of the invention may be used for separating and parsing information such as KB articles as will be described in more detail.

For the sake of brevity, not all components of the normalization and filtering module may be illustrated in FIG. 2B. In one or more embodiments of the invention, the normalization and filtering module (204) may obtain the system telemetry and/or logs and important keywords for a changed datacenter element from the input module (e.g., 202, FIG. 2A) as an input (220). The operation of the normalization and filtering module (204) is explained below.

In step 224, the input (e.g., Washington, D.C., is the capital of the United States of America. It is also home to iconic museums.) is broken into separate sentences (e.g., Washington, D.C., is the capital of the United States of America.).

In step 226, tokenization (e.g., splitting a sentence into smaller portions, such as individual words and/or terms) of important elements of a targeted sentence and the extraction of a token (i.e., keyword) based on the identified group of words occurs. For example, based on step 224, the input is breaking into the smaller portions as “Washington”, “D”, “.”, “C”, “.”, “,”, “is”, “the”, “capital”, “of”, “the”, “United”, “States”, “of”, “America”, “.”.

In step 228, a part of speech (e.g., noun, adjective, verb, etc.) of each token will be determined. In one or more embodiments of the invention, understanding the part of speech of each token will be helpful to figure out the details of the sentence. In one or more embodiments of the invention, in order to perform the part of speech tagging, for example, a pre-trained part of the speech classification model may be implemented. The pre-trained part of speech classification model attempts to determine the part of speech of each token based on similar words identified before. For example, the pre-trained part of speech classification model may consider “Washington” as a noun and “is” as a verb.

In step 230, following the part of speech tagging step, a lemmatization (i.e., identifying the most basic form of each word in a sentence) of each token is performed. In one or more embodiments of the invention, each token may appear in different forms (e.g., capital, capitals, etc.). With the help of lemmatization, the pre-trained part of speech classification model will understand that “capital” and “capitals” are originated from the same word. In one or more embodiments of the invention, lemmatization may be implemented according to a look-up table of lemma forms of words based on their part of speech.

Those skilled in the art will appreciate that while the example discussed in step 230 considers “capital” and “capitals” to implement the lemmatization, any other word may be used to implement the lemmatization without departing from the invention.

In step 232, some of the words in the input (e.g., Washington, D.C., is the capital of the United States of America.) will be flagged and filtered before performing a statistical analysis. In one or more embodiments of the invention, some words (e.g., a, the, and, etc.) may appear more frequently than other words in the input and while performing the statistical analysis, they may create a noise. In one or more embodiments of the invention, these words will be tagged as stop words and they may be identified based on a list of known stop words.

Those skilled in the art will appreciate that while the example discussed in step 232 uses “a”, “the”, “and” as the stop words, any other stop word may be considered to perform flag and filter operation in the statistical analysis without departing from the invention.

Continuing the discussion of FIG. 2B., in step 234, a process of determining the syntactic structure of a sentence (i.e., a parsing process) is performed. In one or more embodiments of the invention, the parsing process may determine how all the words in a sentence relate to each other by creating a parse tree. The parse tree assigns a single parent word to each word in the sentence, in which the root of the parse tree will be the main verb in the sentence. In addition to assigning the single parent word to each word, the parsing process may also determine the type of relationship between those two words. For example, in the following sentence, “Washington, D.C., is the capital of the United States of America,” the parse tree shows “Washington” as the noun and it has a “be” relationship with “capital.”

In step 236, following the parsing process, a named entity recognition process is performed. In one or more embodiments of the invention, some of the nouns in the input (e.g., Washington, D.C., is the capital of the United States of America.) may present real things. For example, “Washington” and “America” represent physical places. In this manner, a list of real things included in the input may be detected and extracted. In one or more embodiments of the invention, to do that, the named entity recognition process applies a statistical analysis such that it may distinguish “George Washington”, the person, and “Washington”, the place, using context clues.

Those skilled in the art will appreciate that while the example discussed in step 236 uses physical location as a context clue for the named entity recognition process, any other context clues (e.g., names of events, product names, dates and times, etc.) may be considered to perform the named entity recognition process without departing from the invention.

Following step 236, the processed input (220) is extracted as normalized and filtered system logs of the device and/or the important keywords for the computing device as an output (238). In one or more embodiments of the invention, the output (238) may be stored in the storage (e.g., 206, FIG. 2A).

Turning now to FIG. 2C, FIG. 2C shows a diagram of a shared storage in accordance with one or more embodiments of the invention. In one or more embodiments of the invention, the shared storage may include one or more KB articles (e.g., KB article 1, KB article 2, KB article 3, etc.), one or more posts (e.g., post 1) posted by the customers. In one or more embodiments of the invention, the KB articles (e.g., “How to configure a new network card?”, “What fan speeds are needed?”, etc.) may include remediation, software version, and component information for the new hardware device. In an embodiment of the invention shown in FIG. 2C, the shared storage includes both the unstructured data (e.g., topic—install, topic—upgrade, etc.) and structured data (e.g., security fix, setup, etc.).

FIG. 3 shows an exemplary component tree (300). In the component tree (300) shown in FIG. 3, a datacenter element (310) (which may have been determined to cause a change in the datacenter, as will be described in more detail below with regards to the method shown in FIG. 4) communicates and/or is associated with two other datacenter elements 2 and 3 (320 and 330). While only two other datacenter elements are shown in FIG. 3, the datacenter element (310) may be related to more hardware elements depending on the specific configuration of the datacenter (e.g., 100, FIG. 1).

As will be described in more detail below with regards to the method shown in FIG. 4, when a datacenter element (e.g., 310) such as a hardware element or application causes a change in the datacenter (e.g., 100, FIG. 1), a component tree (300) is prepared. From this component tree (300), the analyzer (e.g., 120, FIG. 1) may determine how to configure the changed datacenter element (e.g., 310) as well as any dependent datacenter elements (e.g., 320 and 330). Each of the datacenter elements (e.g., 310, 320, and 330) must be configured to work with each other and they each have a configuration (312, 322, and 332). This configuration may be stored in the datacenter element's own memory (such as when the datacenter element is a hardware device but not limited to a flash-based ROM) or the configuration may be stored in the datacenter's shared storage (e.g., 130, FIG. 1) or as part of an operating system's configuration or any other pertinent location. Each datacenter element (310-330) may comprise of a hardware device (such as, but not limited to a network interface card, a storage device, processor, and/or other components of an information handling system/datacenter) and/or one or more software elements (such as applications, databases, operating systems (OS), or any other software). For example, in a non-limiting example, the addition to the datacenter of a new network card may require changes in both the processors that host applications and the applications themselves.

FIG. 4 shows a flowchart describing a method for detecting a change in a datacenter and recommending remediation steps. The method may be performed, for example, by the analyzer (e.g., 120, FIG. 1) and/or any other part of the datacenter (e.g., 100, FIG. 1).

Other components of the system, including those illustrated in FIGS. 1 and 2A-2C may perform all, or a portion of the method of FIG. 4 without departing from the invention. While FIG. 4 is illustrated as a series of steps, any of the steps may be omitted, performed in a different order, additional steps may be included, and/or any or all the steps may be performed in a parallel and/or partially overlapping manner without departing from the invention.

In step 400, telemetry for the datacenter is monitored. The telemetry may be monitored continuously or periodically such as, but not limited to, every second, minute, hour, etc. The telemetry is monitored for the indication of a change in one or more elements of the datacenter. These changes could be a change in configuration/setting, the introduction of a new hardware or software element, or a failure of one or more elements. Alternatively, in one or more embodiments of the invention, the OS or other hardware elements may signal that a change has occurred without the need for continuously or periodically monitoring system telemetry.

The method detects a change in one or more datacenter elements in step 410. This may be detected by a machine learning processes or any other process which notices changes in the telemetry over time that indicated one or more elements of the datacenter have changed in such a way that remediation may be necessary. The changes may, instead or additionally, be detected through error codes and/or other indications indicated by the one or more elements of the datacenter.

Once the change is noted the method determines which datacenter element or elements produced the change or are being affected by the change. The datacenter element may take the form of one or more hardware devices such as but not limited to a network interface card (NIC), a storage device, one or more processors, or any other hardware device. The datacenter element, alternatively, or in addition to may comprise of one or more processes or applications hosted by the datacenter, such applications/processes could be a database application, a web service, an operating system, a virtual server or component, or any other process or application.

Once the datacenter elements that are determined to have been changed or affected by the change are identified in step 410, the method proceeds to step 420. In step 420, the relationship between the changed datacenter elements and those they are dependent on is determined and a component tree is produced. The analyzer (e.g., 120, FIG. 1), analyzes telemetry, logs, and other information to determine which datacenter elements are affected by the change, as well as those elements which are dependent on the change element. As shown in the example of FIG. 3, the various dependent datacenter elements are mapped out and the mapping is saved to the shared storage. Once the component tree is prepared in step 420, the method proceeds to step 430 where all of the affected datacenter elements are determined from the component tree for each of the changed datacenter elements.

Once the method determines which elements are impacted in step 430, the method proceeds to step 440. In step 440, one or more remediation steps are determined. In step 440, in one or more embodiment of the invention, the analyzer (e.g., 120, FIG. 1A) utilizes one or more technical support systems TSS (e.g., 112A-112N, FIG. 1A) to determine one or more remediation steps. As described above the TSS analyze KB articles and other sources for each of the affected datacenter elements to determine which hardware configurations as well as software configurations are needed to ameliorate the issues caused by the change in the one or more datacenter elements. This may include a suggestion to change one or more settings on a hardware device (for example, in a non-limiting example, changing a switch from full duplex to half duplex on a network device) or may involve reconfiguring one or applications or processor (for example, in a non-limiting example, changing failover settings for one or more nodes of a database cluster).

Once one or more remediation steps are determined in step 440, the method proceeds to step 450. The method in step 440 determines if the remediation steps can be performed automatically. For example, if one or the remediation steps is updating one or more values in a configuration file or in an application, this may potentially be performed without human intervention, however if the remediation step requires physical changes in a hardware device (such as plugging in network cables to different ports), the remediation step may not be able to be performed automatically.

If the remediation steps are not able to be performed automatically the method proceeds to step 460, where a user, administrator, manufacture, developer, or other appropriate party is alerted, and the recommended remediation steps are displayed for the user/administrator to perform. Alternatively, if the remediation steps are able to be performed the method proceeds to step 470 where the remediation steps are performed.

Once either step 460 or 470 is performed, the method of FIG. 4 may end.

### EXAMPLES

The following are non-limiting examples of changes in a datacenter that may use remediation in accordance with the methods described above in FIG. 4.

In the first example, a change in a network device, such as a NIC, is noted by monitoring the telemetry. The change results in one or more application using the network device being unable to communicate effectively and/or efficiently. The method determines that the change is a result of the network device being set for half-duplex communications.

Analysis is performed by analyzing a plurality of KB articles and other documentation and a remediation step is determined that should correct the problem. The determined remediation step is changing an attribute value from half duplex to full duplex. In the example, the network device requires the network cables to be placed in different ports when switching from half-duplex to full-duplex. Accordingly, a user is notified that these changes need to be made.

In a second example, in a distributed environment, several applications are communicating to a database cluster. While monitoring telemetry and logs, the analyzer notes that the primary node faced an iSCSI connection error that lasted for over 60 seconds and failover was triggered. A secondary node proceeded to take over requests for the database without issue and as designed. However, many applications in the distributed environment continued to hold the connections with the primary node and a plurality of errors are noted by the analyzer and/or users resulting in an event that needs remediation.

The analyzer proceeds to produce a component tree which shows four applications are affected by the change in the database. The analyzer determines that the various problems may be eliminated by releasing the stale connections on three of the four applications. Because this remediation step may be performed automatically, a message is sent, and the three applications are released. The analyzer then determines all four applications are functioning the event is closed. In one or more optional embodiments of the invention, a user may also be notified that the change has been made and/or if the analyzer determines that all four applications are still not functioning.

Other examples of using the methods outlined above with regards to the method of FIG. 4 may be used. The above examples are non-limiting and intended as an example only.

### End Examples

As discussed above, embodiments of the invention may be implemented using computing devices. FIG. 5 shows a diagram of a computing device in accordance with one or more embodiments of the invention. The computing device (500) may include one or more computer processors (502), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (512) (e.g., Bluetooth interface, infrared interface, network interface, optical interface, etc.), input devices (510), output devices (508), and numerous other elements (not shown) and functionalities. Each of these components is described below.

In one embodiment of the invention, the computer processor(s) (502) may be an integrated circuit for processing instructions. For example, the computer processor(s) may be one or more cores or micro-cores of a processor. The computing device (500) may also include one or more input devices (510), such as a touchscreen, keyboard, mouse, microphone, touchpad, electronic pen, or any other type of input device. Further, the communication interface (512) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment of the invention, the computing device (500) may include one or more output devices (508), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (502), non-persistent storage (504), and persistent storage (506). Many diverse types of computing devices exist, and the aforementioned input and output device(s) may take other forms.

In general, embodiments described herein relate to methods, systems, and non-transitory computer readable mediums storing instructions for re-configuring and/or repairing at least one datacenter element, when a change is detected in the datacenter. In one or more embodiments the datacenter may be running multiple applications on multiple individual computing devices. Each of these devices need to be correctly configured both locally and in the larger computing system in order to allow the applications to function correctly and efficiently.

The invention as described above provides an analyzer, that along with other components of the datacenter, determines dependencies and remediation steps for elements such as hardware and/or applications of the datacenter that have been changed. Based on determined dependencies and the system configuration, the analyzer may determine any physical changes needed to be made to the datacenter as well as ideal configurations for any affected datacenter elements including both hardware and software elements. This results in making correcting any problems that arise during the day-to-day operations of a datacenter, less burdensome to users and administrators. Ultimately making the datacenter be more reliable and easier to maintain.

The problems discussed above should be understood as being examples of problems solved by embodiments of the invention and the invention should not be limited to solving the same/similar problems. The disclosed invention is broadly applicable to address a range of problems beyond those discussed herein.

While embodiments described herein have been described with respect to a limited number of embodiments, those skilled in the art, having the benefit of this Detailed Description, will appreciate that other embodiments may be devised which do not depart from the scope of embodiments as disclosed herein. Accordingly, the scope of embodiments described herein should be limited only by the attached claims.

What is claimed is:

1. A method for mitigating impacts of changes in a datacenter, the method comprising:
retrieving telemetry from the datacenter;
detecting, using the telemetry, a change in the datacenter;
determining, after detecting the change in the datacenter, that the change in the datacenter has affected one or more datacenter elements;
identifying, using the telemetry, the affected one or more of the datacenter elements;
making a component tree for the identified one or more affected datacenter elements;
determining, using at least the component tree for the one or more affected datacenter elements, one or more remediation steps; and
initiating performance of the one or more remediation steps,
wherein the one or more remediation steps comprise of making changes to at least one of the one or more affected datacenter elements.

2. The method of claim 1, wherein the initiating the performance of the one or more remediation steps is performed automatically once the one or more remediation steps are determined.

3. The method of claim 1, further comprising:
notifying a user of the change in the datacenter, wherein the notification of the user includes displaying the one or more remediation steps.

4. The method of claim 1, wherein the one or more affected datacenter elements includes one or more hardware devices.

5. The method of claim 4, wherein the one or more hardware devices includes a network device, and the one or more remediation steps include changing a network setting.

6. The method of claim 4, wherein one or more remediation steps include making a physical change to the one or more hardware devices.

7. The method of claim 6, wherein the physical change to the one or more hardware devices is the replacement of the one or more hardware devices.

8. The method of claim 1, wherein the one or more datacenter elements includes one or more applications and wherein the one or more remediation steps comprises reconfiguring one or more applications.

9. A non-transitory computer readable medium comprising computer readable program code, which when executed by a computer processor enables the computer processor to perform a method for performing a method for mitigating impacts of changes in a datacenter, the method comprising:
retrieving telemetry from the datacenter;
detecting, using the telemetry, a change in the datacenter;
determining, after detecting the change in the datacenter, that the change in the datacenter has affected one or more datacenter elements;
identifying, using the telemetry, the affected one or more of the datacenter elements;
making a component tree for the identified one or more affected datacenter elements;
determining, using at least the component tree for the one or more affected datacenter elements, one or more remediation steps; and
initiating performance of the one or more remediation steps,
wherein the one or more remediation steps comprise of making changes to at least one of the one or more affected datacenter elements.

10. The non-transitory computer readable medium of claim 9, wherein the initiating the performance of the one or more remediation steps is performed automatically once the one or more remediation steps are determined.

11. The non-transitory computer readable medium of claim 9, further comprising:
notifying a user of the change in the datacenter, wherein the notification of the user includes displaying the one or more remediation steps.

12. The non-transitory computer readable medium of claim 9, wherein the one or more remediation steps include making a physical change to the one or more hardware devices.

13. The non-transitory computer readable medium of claim 9, wherein the one or more datacenter elements include one or more applications and wherein the one or more remediation steps comprises reconfiguring one or more applications.

14. A system comprising:
a datacenter which comprises:
at least one processor; and
at least one memory that includes instructions, which when executed by the processor, performs a method for mitigating impacts of changes in the datacenter, the method comprising, the method comprising:
retrieving telemetry from the datacenter;
detecting, using the telemetry, a change in the datacenter;
determining, after detecting the change in the datacenter, that the change in the datacenter has affected one or more datacenter elements;
identifying, using the telemetry, the affected one or more of the datacenter elements;
making a component tree for the identified one or more affected datacenter elements;
determining, using at least the component tree for the one or more affected datacenter elements, one or more remediation steps; and
initiating performance of the one or more remediation steps,
wherein the one or more remediation steps comprise of making changes to at least one of the one or more affected datacenter elements.

15. The system of claim 14, wherein the initiating the performance of the one or more remediation steps is performed automatically once the one or more remediation steps are determined.

16. The system of claim 14, wherein the method further comprises:
notifying a user of the change in the datacenter, wherein the notification of the user includes displaying the one or more remediation steps.

17. The system of claim 16, wherein the one or more affected datacenter elements includes one or more hardware devices.

18. The system of claim 16, wherein the one or more remediation steps includes making a physical change to the one or more hardware devices.

19. The system of claim 18, wherein the one or more hardware devices includes a network device, and the physical change to the one or more hardware devices includes changing a network setting.

20. The system of claim 14, wherein the one or more datacenter elements includes one or more applications and wherein the one or more remediation steps comprises reconfiguring the one or more applications.
